(19) United States
(12) Patent Application Publication
(10) Pub. No.: US 2023/0415806 A1
(43) Pub. Date: Dec. 28, 2023

(54) BABY STROLLER FRAME

(71) Applicant: WONDERLAND SWITZERLAND AG, Steinhausen (CH)

(72) Inventor: Zongwang CUI, Dongguan, Guangdong (CN)

(21) Appl. No.: 18/252,167

(22) PCT Filed: Oct. 29, 2021
(86) PCT No.: PCT/IB2021/060022

§ 371 Date: May 8, 2023

(30) Foreign Application Priority Data
Nov. 9, 2020 (CN) 202011244367.X

(51) Int. Cl. B62B 7/08; B62B 7/06; B62B 7/00; B62B 9/14

(52) U.S. Cl. CPC B62B 7/083; B62B 7/066; B62B 7/008; B62B 7/062; B62B 9/142; B62B 2205/20

(57) ABSTRACT

The disclosure provides a baby stroller frame switchable between a stretched position and a retracted position, comprising a retracting-stretching device, a front leg, a rear leg, a front carrying stand, and a rear carrying stand. The front leg is pivotally connected to the retracting-stretching device. The rear leg is pivotally connected to the retracting-stretching device. The rear leg and the front leg perform a stretching or retracting movement in respect to each other by assistance of the retracting-stretching device. The front carrying stand is pivotally connected to the retracting-stretching device. The rear carrying stand is pivotally connected to the retracting-stretching device. The rear carrying stand and front carrying stand perform a stretching or retracting movement in respect to each other by assistance of the retracting-stretching device.

### CROSS-REFERENCE TO RELATED APPLICATIONS

This application is a National Stage application of PCT/IB2021/060022; filed Oct. 29, 2021, which claims the benefit of Chinese Application No. 202011244367.X, filed on Nov. 9, 2020, both of which are incorporated herein by reference in their entirety.

### TECHNICAL FIELD

The disclosure relates to a baby stroller, and particularly to a baby stroller frame which occupies a small space after being retracted and is convenient for retracting operation.

### BACKGROUND

As the continuous society progress and the continuous development of the economy, as well as the continuous improvement of science and technology, people may enjoy more and more consumer goods, thereby creating extremely excellent material conditions for improving people's living standards. Moreover, a baby stroller is a kind of the consumer goods.

It is well known, there are many types of baby strollers on the market, such as a baby carriage. For parents with children at home, when they take their children out for shopping or walking, they usually use baby carriages instead of hands to carry children, so as to reduce the burden on adults, thus providing great convenience for parents with children. Therefore, baby carriages are more and more popular among people.

At present, if a baby carriage is not in use, then it is necessary to store it. However, the existing baby carriages occupy a lot of space after being retracted due to their unreasonable frame designs. Meanwhile, the frames also have the defect of inconvenient retracting operations.

Therefore, there is an urgent need for a baby stroller frame which occupies a small space after being retracted and is easy to operate when retracted to overcome the above-mentioned defect.

### SUMMARY

The disclosure aims to provide a baby stroller frame which occupies a small space after being retracted and is easy for retracting operation.

In order to achieve the above objections, the disclosure provides a baby stroller frame switchable between a stretched position and a retracted position, comprising a retracting-stretching device, a front leg, a rear leg, a front carrying stand, and a rear carrying stand; the front leg being pivotally connected to the retracting-stretching device; the rear leg being pivotally connected to the retracting-stretching device, the rear leg and the front leg performing a stretching or retracting movement in respect to each other by assistance of the retracting-stretching device; the front carrying stand being pivotally connected to the retracting-stretching device; the rear carrying stand being pivotally connected to the retracting-stretching device, and the rear carrying stand and the front carrying stand performing a stretching or retracting movement in respect to each other by assistance of the retracting-stretching device; wherein during a process that the baby stroller frame is switched from the stretched position to the retracted position, while the front leg and the rear leg are pivotally retracting close to each other, the front carrying stand and the rear carrying stand are pivotally retracting close to each other, thereby achieving a retracting of the baby stroller frame.

Preferably, the front carrying stand is connected to the front leg, and the rear carrying stand is connected to the rear leg.

Preferably, the front carrying stand is pivotally connected to the front leg, the rear carrying stand is pivotally connected to the rear leg; and during a process that the front leg and the rear leg are pivotally retracting close to each other, the front carrying stand and the rear carrying stand are linked to pivotally retract close to each other.

Preferably, during a process that the front leg and the rear leg are pivotally retracting upwardly close to each other, the front carrying stand and the rear carrying stand are linked to be pivotally retracting downwardly close to each other; or during a process that the front leg and the rear leg are pivotally retracting downwardly close to each other, the front carrying stand and the rear carrying stand are linked to be pivotally retracting upwardly close to each other.

Preferably, the front carrying stand is located on an inner side of the front leg, and the rear carrying stand is located on an inner side of the rear leg.

Preferably, the retracting-stretching device includes a device skeleton and a movable mount; the device skeleton is pivotally connected to the front leg and the rear leg respectively; the movable mount is slidably arranged on the device skeleton, the movable mount is pivotally connected to the front carrying stand and the rear carrying stand respectively; and during a process that the front leg and the rear leg are pivotally retracting close to each other, the front carrying stand and the rear carrying stand are also linked to slide along with the movable mount.

Preferably, the device skeleton includes a base pivotally connected to the front leg and rear the leg respectively and an intermediate connecting support with a top end assembled on the base, and the movable mount is slidably arranged on the intermediate connecting support in the up-down direction.

Preferably, the retracting-stretching device further includes a locking member, the locking member is movably arranged on one of the device skeleton and the movable mount, and the other one of the device skeleton and the movable mount is provided with a slotted structure for cooperating with the locking member, and the locking member is switchable between a locked position for locking with the slotted structure and an unlocked position for separating from the slotted structure.

Preferably, the locking member is located on the base, and the intermediate connecting support is provided with a through hole for the locking member to move through and to be locked with the slotted structure.

Preferably, the locking member is axially slidable in the through hole.

Preferably, the retracting-stretching device further includes an operating member movably arranged on the device skeleton or the movable mount on which the locking member is located, and the operating member is used to drive the locking member to move to the unlocked position.

Preferably, the operating member is provided with a driving inclined surface inclined in respect to an axial direction, the locking member is provided with a driven inclined surface cooperating with the driving inclined surface, and the operating member during a moving process drives the locking member to move to the unlocked position by a cooperation of the driving inclined surface and the driven inclined surface.

Preferably, the operating member is a button, and the button is slidable in the up-down direction.

Preferably, the retracting-stretching device further includes an elastic element for driving the locking member to move the locking member to the locked position.

Preferably, the elastic element is a spring, and the spring is arranged between the locking member and the device skeleton or the movable mount on which the locking member is located.

Preferably, the baby stroller frame further comprises a front canopy support and a rear canopy support; the front canopy support is pivotally connected to the front leg, the rear canopy support is pivotally connected to the rear leg; and during a process that the baby stroller frame is switched from the stretched position to the retracted position, the front canopy support is pivoted forward and downward to a position abutting against the front leg, and the rear canopy support is pivoted backward and downward to a position abutting against the rear leg.

Preferably, the baby stroller frame further comprises a dining plate detachably assembled to the device skeleton.

Preferably, an elastic engaging finger is formed on the dining plate, the dining plate is clamped to the device skeleton by assistance of the elastic engaging finger.

Preferably, the elastic engaging finger extends downward and protrudes.

Preferably, the baby stroller frame further comprises a front wheel arranged at a bottom of the front leg and a rear wheel arranged at a bottom of the rear leg, and the front wheel and the rear wheel abut against each other when the baby stroller frame is in the retracted position.

Preferably, the baby stroller frame further comprises a handrail pivotally connected to the front leg, the handrail is switchable between a pushed backward position and a dragged forward position, when the handrail is pivoted to the pushed backward position it is be on the same side as the rear leg, when the handrail is pivoted to the dragged forward position it is be on the same side as the front leg.

Preferably, the handrail is located on an outer side of both the front leg and the rear leg.

Preferably, the baby stroller frame further comprises a handrail, the handrail includes a sleeve assembled on the front leg and a hand lever arranged passing through the sleeve; a bottom end of the hand lever passes downward through the sleeve and extends to a front of the front wheel when the baby stroller frame is in the retracted position, such that the baby stroller frame stands on the ground by assistance of a bottom end of the hand lever, the front wheel, and the rear wheel.

Preferably, the sleeve is pivotally connected to the front leg, the handrail is switchable between a pushed backward position and a dragged forward position, when the handrail is pivoted to the pushed backward position it is on the same side as the rear leg, and when the handrail is pivoted to the dragged forward position it is on the same side as the front leg.

Preferably, the sleeve is located on an outer side of the front leg.

Preferably, a handrail anchoring member is arranged between the sleeve and the front leg, and when the handrail is pivoted to the pushed backward position the handrail anchoring member anchors the handrail and the front leg.

Preferably, the handrail anchoring member is rotatably assembled on one of the sleeve and the front leg, and the other one of the sleeve and the front leg is provided with a cooperatively anchoring structure cooperating with the handrail anchoring member.

Preferably, the baby stroller frame further comprises an anchoring elastic member assembled on the sleeve or the front leg on which the handrail anchoring member is located, the anchoring elastic member is used to drive the handrail anchoring member to move in a direction of locking with the cooperatively anchoring structure.

Preferably, a bottom end of the sleeve is pivotally connected to the front leg, and the cooperatively anchoring structure is located at a top end of the sleeve.

Preferably, the front leg, the rear leg, the base, and the movable mount are respectively arranged at intervals to be one on left and one on right.

Preferably, wherein the front carrying stand, the rear carrying stand, and the intermediate connecting support each is in a shape of “U”, each of left and right sides of a rear end of the front carrying stand is pivotally connected to the movable mount on the same side, each of left and right sides of a front end of the front carrying stand is pivotally connected to the front leg on the same side, each of left and right sides of a front end of the rear carrying stand is pivotally connected to the movable mount on the same side, each of left and right sides of a rear end of the rear carrying stand is pivotally connected to the rear leg on the same side, each of the front legs on left and right sides is pivotally connected to the base on the same side, each of the rear legs on left and right sides is pivotally connected to the base on the same side, each of left and right sides of a top end of the intermediate connecting support is assembled and connected with the base on the same side.

In order to achieve the above objections, the baby stroller frame of the disclosure may be switched between a stretched position and a retracted position, comprises: a retracting-stretching device, a front leg, a rear leg, a front carrying stand, and a rear carrying stand. The retracting-stretching device includes: a device skeleton and a movable mount separably connected to the device skeleton, the movable mount being engaged with the device skeleton when the baby stroller frame is in the stretched position, and the movable mount being separated from the device skeleton when the baby stroller frame is in the retracted position; a front leg pivotally connected to the device skeleton; a rear leg pivotally connected to the device skeleton, the rear leg and the front leg performing a stretching or retracting movement in respect to each other by assistance of the retracting-stretching device; a front carrying stand pivotally connected to the movable mount, and also pivotally connected to the front leg; and a rear carrying stand pivotally connected to the movable mount, and also pivotally connected to the rear leg, the rear carrying stand and the front carrying stand performing a stretching or retracting movement in respect to each other by assistance of the retracting-stretching device; wherein the front leg and the rear leg in a process of pivotally retracting close to each other link the front carrying stand and the rear carrying stand to follow a separation of the movable mount in respect to the device skeleton to pivotally retract close to each other, thereby achieving a retracting of the baby stroller frame.

Compared with the related art, since the front leg is pivotally connected to the retracting-stretching device, the rear leg is pivotally connected to the retracting-stretching device, and the rear leg performs stretching or retracting movement with the front leg in respect to each other by assistance of the retracting-stretching device; at the same time, the front carrying stand is pivotally connected to the retracting-stretching device, the rear carrying stand is pivotally connected to the retracting-stretching device, and the rear carrying stand performs stretching or retracting movement with the front carrying stand in respect to each other by assistance of the retracting-stretching device. Therefore, in the process that the baby stroller frame of the disclosure is switched from the stretched position to the retracted position, while the front leg and the rear leg 20b are pivotally retracting close to each other, the front carrying stand 30a and the rear carrying stand are pivotally retracting close to each other, so on the one hand, the front leg, the rear leg, the front carrying stand, and the rear carrying stand after retracted are compact, such that the baby stroller frame of the disclosure occupies a smaller space, and on the other hand, the retracting operation of the baby stroller frame of the disclosure is convenient.

### BRIEF DESCRIPTION OF THE DRAWINGS

FIG. 1 is a perspective structural schematic view of a baby stroller frame of a first embodiment of the disclosure in a stretched position.

FIG. 2 is a plan structural schematic view of the baby stroller frame shown in FIG. 1 viewed from front to rear.

FIG. 3 is a perspective structural schematic view of the baby stroller frame shown in FIG. 1 after a canopy support is pivotally and downwardly retracted.

FIG. 4 is a perspective structural schematic view of the baby stroller frame shown in FIG. 3 after a handrail is backwardly retracted.

FIG. 5 is a perspective structural schematic view of the baby stroller frame shown in FIG. 1 in a retracted position.

FIG. 6 is a perspective structural schematic view of the baby stroller frame shown in FIG. 1 when a handrail is in a dragged forward position.

FIG. 7 is a perspective structural schematic view of a retracting-stretching device in the baby stroller frame of the first embodiment of the disclosure.

FIG. 8 is a perspective exploded schematic view of a part of the structure in the retracting-stretching device shown in FIG. 7.

FIG. 9 is a schematic view of a part of the internal structure of the baby stroller frame of the first embodiment of the disclosure after being cut away at a position where its dining plate engages with a base of a retracting-stretching device.

FIG. 10 is a perspective structural schematic view of the dining plate in the baby stroller frame of the first embodiment of the disclosure.

FIG. 11 is a schematic view of the internal structure of the baby stroller frame of the first embodiment of the disclosure when the handrail and the front leg engage with each other by a handrail and a cooperatively anchoring structure.

FIG. 12 is a plan structural schematic view of the baby stroller frame of the second embodiment of the disclosure in the stretched position.

FIG. 13 is a perspective structural schematic view of the baby stroller frame shown in FIG. 12 in the retracted position.

### DETAILED DESCRIPTION

In order to describe the technical content and structural features of the disclosure in detail, the following description will further provided in conjunction with the embodiments and the accompanying drawings.

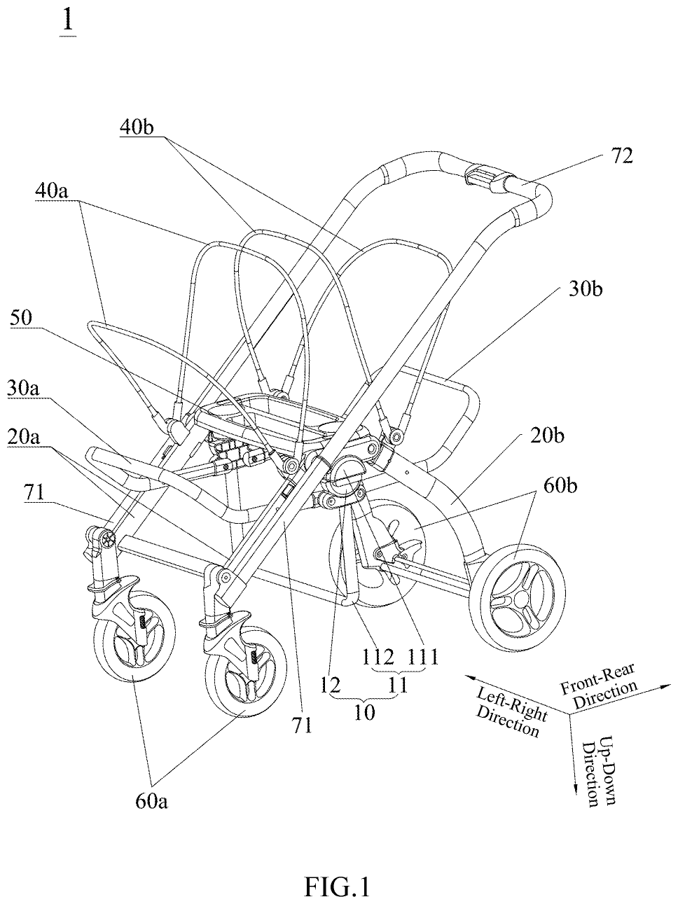

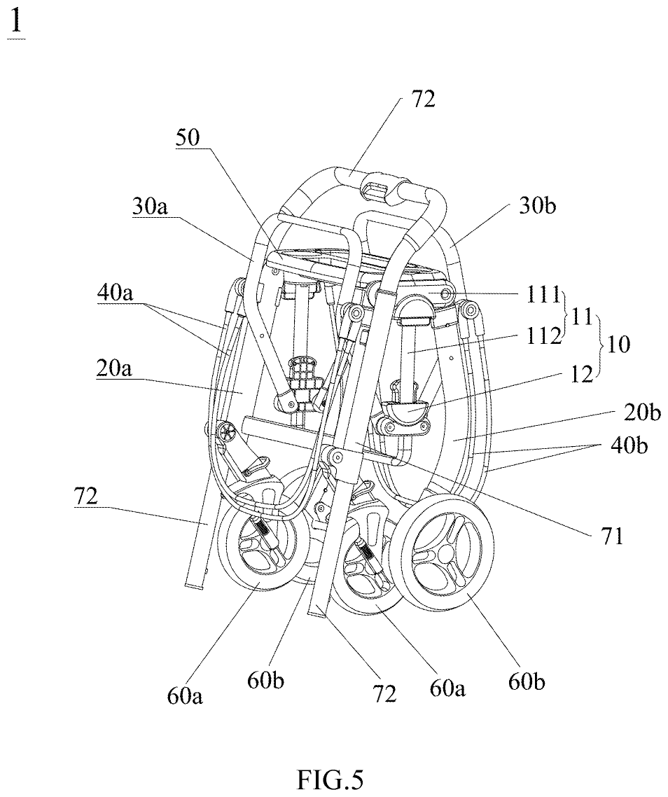

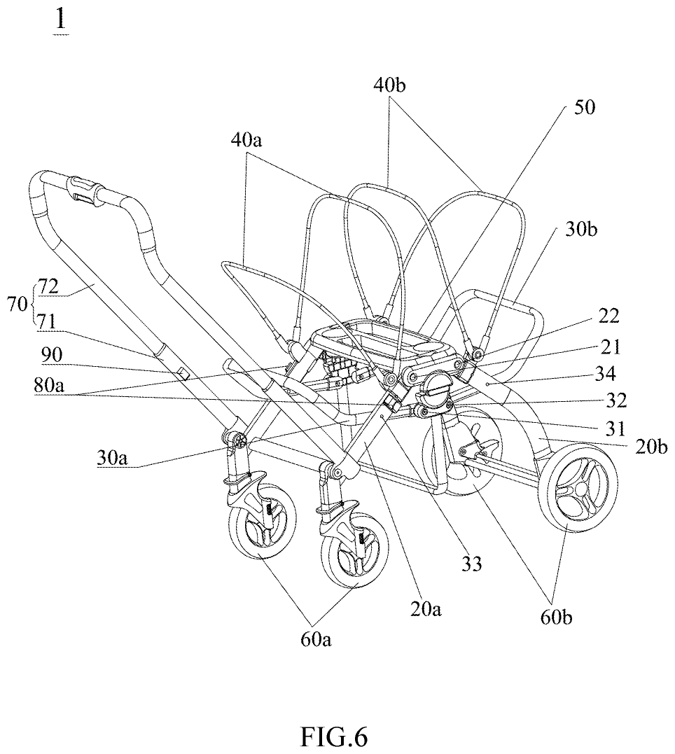

Please refer to FIGS. 1 and 5, a baby stroller frame 1 of a first embodiment of the disclosure may be switched between an stretched position shown in FIG. 1 and retracted position shown in FIG. 5. The baby stroller frame 1 includes a retracting-stretching device 10, a rear front leg 20a, a rear leg 20b, a front carrying stand 30a and a rear carrying stand 30b. The front leg 20a is pivotally connected to the retracting-stretching device 10, and the rear leg 20b is pivotally connected to the retracting-stretching device 10, such that the rear leg 20b and the front leg 20a may perform a stretching or retracting movement in respect to each other via the retracting-stretching device 10. Preferably, in FIG. 6, the pivot connection between the front leg 20a and the retracting-stretching device 10 forms a first pivotal connection point 21, and the pivot connection between the rear leg 20b and the retracting-stretching device 10 forms a second pivotal connection point 22. Preferably, the first pivotal connection point 21 is located directly in front of the second pivotal connection point 22, such that the first pivotal connection point 21 does not coincide with the second pivotal connection point 22, but the disclosure is not limited to this. The front carrying stand 30a is pivotally connected to the retracting-stretching device 10, and the rear carrying stand is pivotally connected to the retracting-stretching device 10, such that the rear carrying stand and the front carrying stand 30a may perform a stretching or retracting movement in respect to each other via the retracting-stretching device 10. Preferably, in FIG. 6, the pivot connection between the front carrying stand 30a and the retracting-stretching device 10 forms a third pivotal connection point 31; the pivot connection between the rear carrying stand 30b and the retracting-stretching device 10 forms a fourth pivotal connection point 32, and third pivotal connection point 31 is located directly in front of the fourth pivotal connection point 32, such that the third pivotal connection point 31 does not coincide with the fourth pivotal connection point 32, but the disclosure is not limited to this. Among them, during the process that the baby stroller frame 1 of the first embodiment of the disclosure is switched from the stretched position shown in FIG. 1 to the retracted position shown in FIG. 5, while the front leg 20a and the rear leg 20b are pivotally retracting downwardly close to each other, the front carrying stand 30a and the rear carrying stand are pivotally retracting upwardly close to each other, so as to achieve a retracting of the baby stroller frame 1 of the first embodiment of the disclosure. Of course, in other embodiments, while the front leg 20a and the rear leg 20b are pivotally retracting upwardly close to each other, the front carrying stand 30a and the rear carrying stand 30b may be pivotally retracting downwardly close to each other, so as to achieve a retracting of the baby stroller frame 1 of the first embodiment of the disclosure, so the disclosure is not limited to this. Specifically, in order to achieve “while the front leg 20a and the rear leg 20b are pivotally retracting close to each other, the front carrying stand 30a and the rear carrying stand 30b are pivotally retracting close to each other,” the front carrying stand 30a is connected to the front leg 20a, and the rear carrying stand 30b is connected to the rear leg 20b. Preferably, the front carrying stand 30a is also pivotally connected to the front leg 20a, and the rear carrying stand 30b is also pivotally connected to the rear leg 20b, such that during the process that the front leg 20a and the rear leg 20b are pivotally retracting downwardly close to each other, and the front carrying stand 30a and the rear carrying stand 30b are linked to be pivotally retracting upwardly close to each other. Of course, in other embodiments, during the process that the front leg 20a and the rear leg 20b are pivotally retracting upwardly close to each other, the front carrying stand 30a and the rear carrying stand 30b may also be linked to be pivotally retracting downwardly close to each other, so the disclosure is not limited to this. Since the front carrying stand 30a is also pivotally connected to the front leg 20a, and the rear carrying stand 30b is also pivotally connected to the rear leg 20b, in FIG. 6, the pivot connection between the front carrying stand 30a and the front leg 20a forms a fifth pivotal connection point 33, and the pivot connection between the rear carrying stand 30b and the rear leg 20b forms a sixth pivotal connection point 34, such that the third pivotal connection point 31 and the fourth pivotal connection point 32 each is located between the fifth pivotal connection point 33 and the sixth pivotal connection point 34 in a front-rear direction of the baby stroller frame 1 of the first embodiment of the disclosure, but the disclosure is not limited to this. Preferably, the front carrying stand 30a is located on an inner side of the front leg 20a, and the rear carrying stand 30b is located on an inner side of the rear leg 20b, so as to facilitate the front carrying stand 30a and the rear carrying stand 30b to carry the baby carrier. Moreover, the front carrying stand 30a extends forward from the front leg 20a, and the rear carrying stand 30b extends backward from the rear leg 20b, so as to further facilitate the front carrying stand 30a and the rear carrying stand 30b to carry the baby carrier (e.g., the baby carrier includes but not limited to a sleeping box). It would be noted, extending forward refers to extending from the front of the baby stroller frame 1 of the first embodiment of the disclosure, and extending backward refers to extending from the rear of the baby stroller frame 1 of the first embodiment of the disclosure. More specifically, as follows:

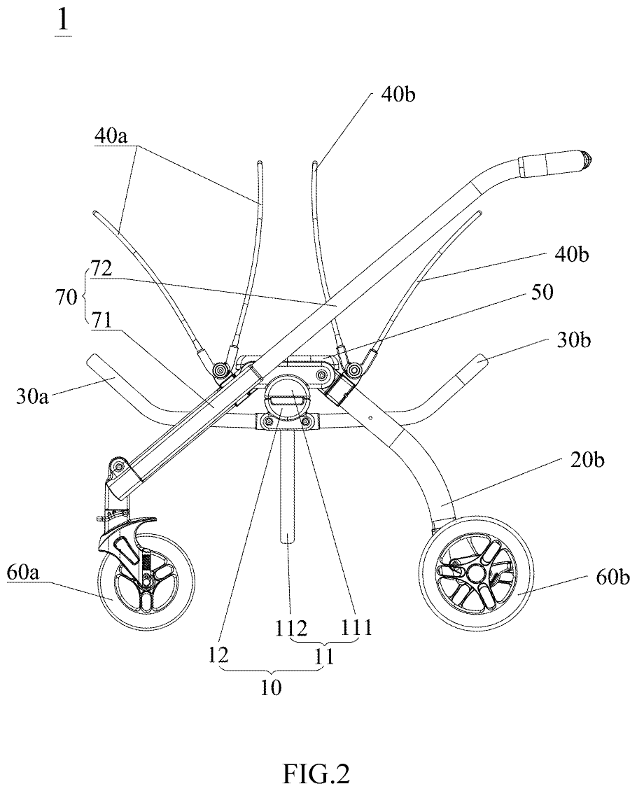

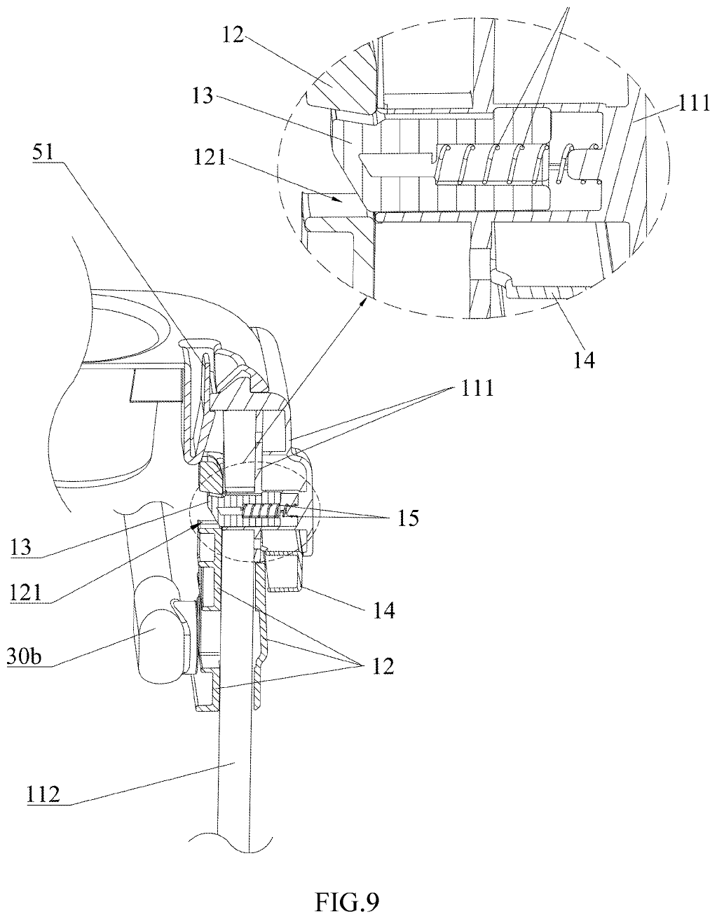

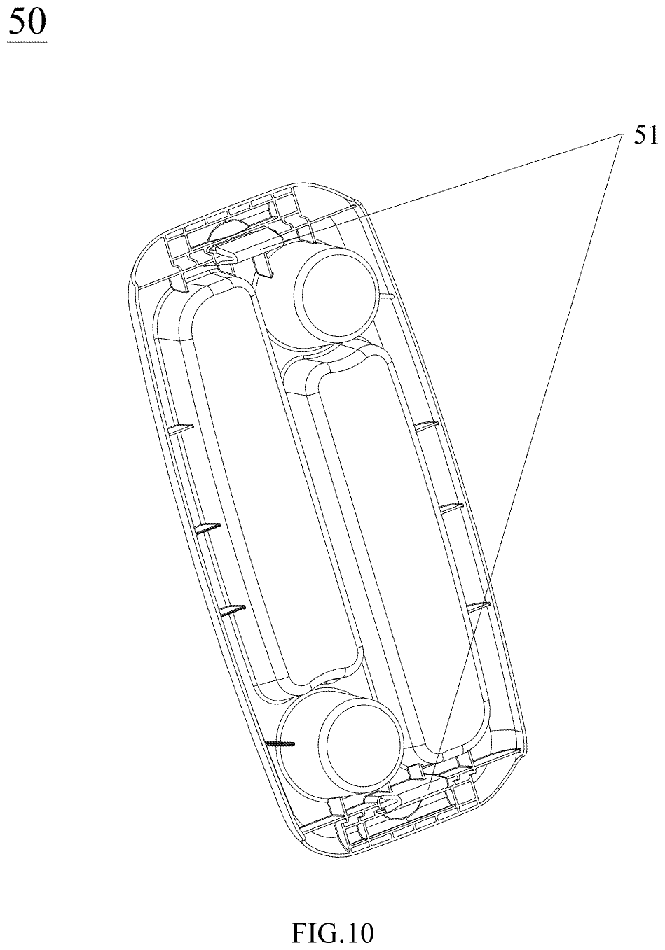

As shown in FIGS. 1 to 6, the baby stroller frame 1 of the first embodiment of the disclosure further includes a front canopy support 40a, a rear canopy support 40b, a dining plate a front wheel 60a, a rear wheel 60b, and a handrail 70. The front canopy support 40a is pivotally connected to the front leg 20a, and the rear canopy support 40b is pivotally connected to the rear leg 20b, so in the process that the baby stroller frame 1 of the first embodiment of the disclosure is switching from the stretched position shown in FIG. 1 to the retracted position shown in FIG. 5, the front canopy support 40a is pivoted forward and downward to a position abutting against the front leg 20a, and the rear canopy support 40b is pivoted backward and downward to a position abutting against the rear leg 20b, such that the retracted baby stroller frame 1 is more compact, as the state shown in FIG. 5. The front wheel 60a is arranged at a bottom of the front leg 20a, the rear wheel 60b is arranged at a bottom of the rear leg 20b, such that the baby stroller frame 1 of the first embodiment of the disclosure stands on the ground while in the stretched position by assistance of the front wheel 60a and the rear wheel 60b, and the front wheel 60a and the rear wheel 60b abut against to each other when the baby stroller frame 1 of the first embodiment of the disclosure is in the retracted position, as the state shown in FIG. 5. The dining plate 50 is detachably assembled to the device skeleton 11 described below, so as to facilitate assembling and disassembling operations between the dining plate 50 and the device skeleton 11. Specifically, in FIGS. 9 and 10, an elastic engaging finger 51 is formed on the dining plate 50. Preferably, the elastic engaging finger 51 extends downward and protrudes, such that the dining plate 50 is clamped to the device skeleton 11 by assistance of the elastic engaging finger 51, so as to simplify the detachable structure between the dining plate 50 and the device skeleton 11, and facilitate assembling and disassembling operations of the dining plate 50, but the disclosure is not limited to this. The handrail 70 includes a sleeve 71 assembled on the front leg 20a and a hand lever 72 arranged passing through the sleeve 71. When the baby stroller frame 1 of the first embodiment of the disclosure is in the retracted position shown in FIG. 5, a bottom end of the hand lever 72 passes downward through the sleeve 71 and extends to the front of the front wheel 60a, such that the baby stroller frame 1, when switched to the retracted position, may stand on the ground by assistance of the bottom end of the hand lever 72, the front wheel 60a and the rear wheel 60b, thereby further facilitating a handling of the retracted baby stroller frame 1. Of course, according to actual requirements, the sleeve 71 and the hand lever 72 may be made into an integrated structure. At this time, the handrail 70 is pivotally connected to the front leg 20a. Preferably, a bottom end of the handrail 70 is pivotally connected to the front leg 20a, such that the handrail 70 may be switched between the pushed backward position shown in FIG. 1 and the dragged forward position shown in FIG. 6. When the handrail 70 is pivoted to the pushed backward position it will be on the same side as the rear leg 20b, and when the handrail 70 is pivoted to the dragged forward position it will be on the same side as the front leg 20a, so as to facilitate user's pushing operation to the baby stroller frame 1 of the first embodiment of the disclosure when the handrail 70 is in the pushed backward position shown in FIG. 1, and user's dragging operation to the baby stroller frame 1 of the first embodiment of the disclosure when the handrail 70 is in the dragged forward position shown in FIG. 6. Preferably, when the sleeve 71 and the hand lever 72 are made into an integrated structure, the handrail 70 at this time is located on an outer side of both the front leg 20a and the rear leg 20b, thereby more facilitating the switching operations of the handrail 70 between the pushed backward position and the dragged forward position.

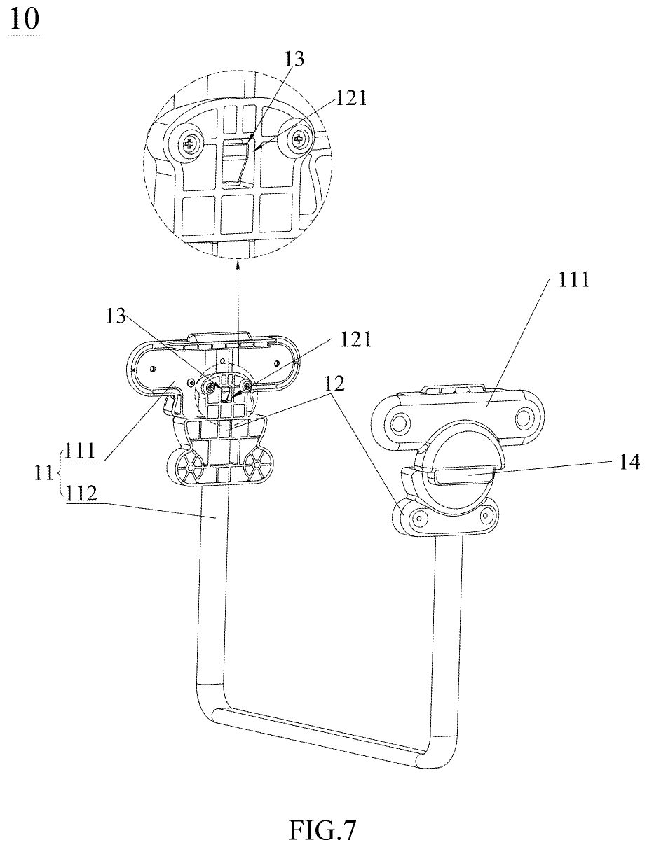

As shown in FIGS. 7 to 9, the retracting-stretching device 10 includes a device skeleton 11, a movable mount 12, a locking member 13, an operating member 14, and an elastic element 15. In addition, referring to FIGS. 1 to 6, the device skeleton 11 is pivotally connected to the front leg 20a and the rear leg 20b respectively. The movable mount 12 is slidably arranged on the device skeleton 11, and the movable mount 12 is pivotally connected to the front carrying stand and the rear carrying stand 30b respectively, such that during the process that the front leg 20a and the rear leg 20b are pivotally retracting downwardly close to each other, the front carrying stand 30a and the rear carrying stand 30b are also linked to slide down along with the movable mount 12. Of course, according to actual requirements, during the process that the front leg 20a and the rear leg 20b are pivotally retracting downwardly close to each other, the front carrying stand 30a and the rear carrying stand 30b may be also linked to slide upward along with the movable mount 12. Therefore, during the process that the front leg 20a and the rear leg 20b are pivotally retracting to close to each other, the front carrying stand 30a and the rear carrying stand are also linked to slide along with the movable mount 12, so on the one hand, the front leg the rear leg 20b, the front carrying stand 30a, and the rear carrying stand 30b are more compact after retracted, and on the other hand, the smoothness of their retracting may be improved. As shown in FIG. 9, the locking member 13 is movably arranged on the device skeleton 11, and the movable mount 12 is provided with a slotted structure 121 for cooperating with the locking member 13, such that the locking member 13 may be switched between a locked position where it is locked to the slotted structure 121 and an unlocked position where it is separated from the slotted structure 121, so as to block or unblock a sliding of the movable mount 12 in respect to the device skeleton 11. Of course, according to actual requirements, the locking member 13 may be movably arranged on the movable mount 12, and correspondingly, the device skeleton 11 is provided with a slotted structure 121 for cooperating with the locking member 13, so the disclosure is not limited to this. The operating member 14 is movably arranged on the device skeleton 11 where the locking member 13 is located. The operating member 14 is used to drive the locking member 13 to move to the unlocked position, and the locking member 13 is brought by the operating member 14 to perform an unlocking movement. The elastic element 15 is used to drive the locking member 13, so as to move the locking member 13 to the locked position shown in FIG. 9. It would be understood, if the locking member 13 is located on the movable mount 12, the operating member 14 is also located on the movable mount 12 at this time, so the disclosure is not limited to this. More specifically as follows:

As shown in FIGS. 1 to 6, the device skeleton 11 includes a base 111 and an intermediate connecting support 112 with a top end assembled on the base 111. The base 111 is pivotally connected to the front leg 20a and the rear leg 20b respectively. The movable mount 12 is slidably arranged on the intermediate connecting support 112 in the up-down direction, so as to bear and support the baby carrier from bottom by assistance of the intermediate connecting support 112, and provide guidance for the upward and downward sliding movement of the movable mount 12, thereby ensuring the smoothness of the sliding movement of the movable mount 12 in the up-down direction. It would be understood, if the device skeleton 11 includes the base 111 and the intermediate connecting support 112, then the first pivotal connection point 21 is formed by the pivot connection between the front leg 20a and the base 111, and the second pivotal connection point 22 is formed by the pivot connection between the rear leg 20b and the base 111.

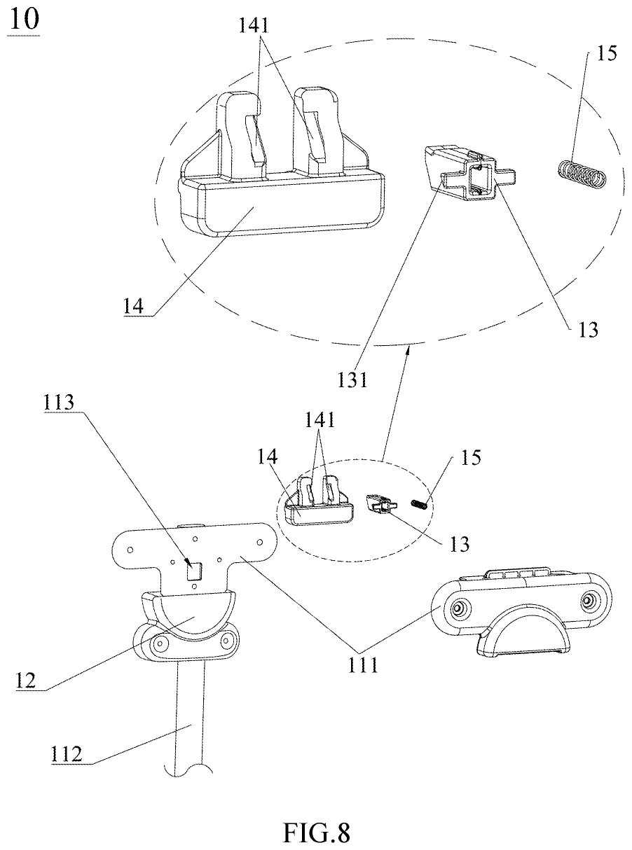

As shown in FIGS. 8 to 9, the locking member 13 is located on the base 111, and the intermediate connecting support 112 is provided with a through hole 113 for the locking member 13 to move through and to be locked with the slotted structure 121 then, such design may increase a locking reliability between the locking member 13 and the movable mount 12. Specifically, the locking member 13 may slide axially in the through hole 113, such that the locking member 13 may perform a locking between the intermediate connecting support 112 and the movable mount 12 more directly and reliably, but the disclosure is not limited to this.

As shown in FIGS. 8 to 9, the operating member 14 is provided with a driving inclined surface 141 inclined in respect to the axial direction, and the locking member 13 is provided with a driven inclined surface 131 cooperating with the driving inclined surface 141, such that the operating member 14 during a moving process drives the locking member 13 to be moved to the unlocked position by the cooperation of the driving inclined surface 141 and driven inclined surface 131. For example, the operating member 16 may be a button, and the button can slide in the up-down direction, which is more convenient for the user to perform an unlocking operation to the operating member 16 by pressing.

As shown in FIGS. 8 to 9, the elastic element 15 may be a spring, and the spring is arranged between the locking member 13 and the device skeleton 11, so as to simplify the assembly and connection of the elastic element 15 respective with the locking member 13 and the device skeleton 11. It would be understood, if the locking member 13 is movably arranged on the movable mount 12, then the spring is arranged between the locking member 13 and the movable mount 12, so the disclosure is not limited to this.

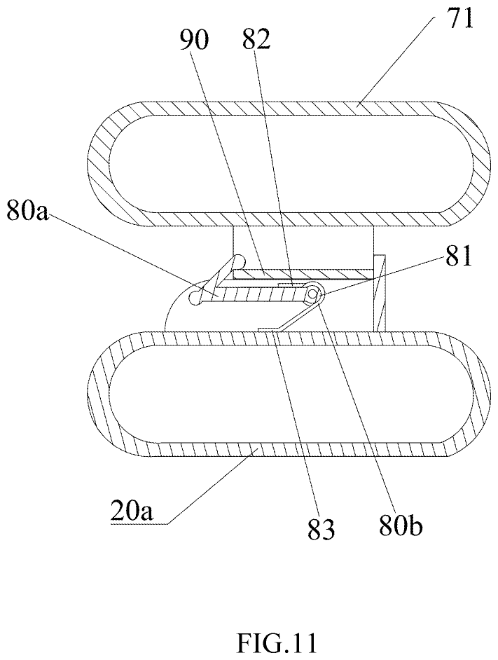

As shown in FIGS. 1 to 6, the sleeve 71 is pivotally connected to the front leg 20a, such that the handrail 70 may be switched between the pushed backward position shown in FIG. 1 and the dragged forward position shown in FIG. 6. When the handrail 70 is pivoted to the pushed backward position it is on the same side as the rear leg 20b, and when the handrail 70 is pivoted to the dragged forward position it is on the same side as the front leg 20a, so as to facilitate the user's pushing operation to the baby stroller frame 1 of the first embodiment of the disclosure when the handrail 70 is in the pushed backward position shown in FIG. 1 and the user's dragging operation to the baby stroller frame 1 of the first embodiment of the disclosure when the handrail 70 is in the dragged forward position shown in FIG. 6. Preferably, the sleeve 71 is located on an outer side of the front leg 20a, to further facilitate the switching operation of the handrail 70 between the pushed backward position and the dragged forward position. Specifically, in conjunction with FIG. 11, a handrail anchoring member 80a is arranged between the sleeve 71 and the front leg 20a, such that when the handrail 70 is pivoted to the pushed backward position shown in FIG. 6, the handrail anchoring member 80a anchors the handrail 70 and the front leg 20a, so as to improve safety in use. More specifically, the handrail anchoring member 80a is rotatably assembled on the front leg 20a, and the sleeve 71 is provided with a cooperatively anchoring structure 90 cooperating with the handrail anchoring member 80a. Of course, according to actual requirements, the handrail anchoring member 80a may be rotatably assembled to the sleeve 71, and correspondingly, the cooperatively anchoring structure 90 is arranged on the front leg 20a. In order to prevent the handrail 70 in the pushed backward position from accidental pivoting, in FIG. 11, the baby stroller frame 1 of the first embodiment of the disclosure further includes an anchoring elastic member 80b. The anchoring elastic member 80b is used to drive the handrail anchoring member 80a to move in a direction of locking with the cooperatively anchoring structure 90, such that an automatic locking between the handrail anchoring member 80a and the cooperatively anchoring structure 90 may be more convenient. Specifically, the anchoring elastic member 80b is arranged between the handrail anchoring member 80a and the front leg 20a at which the handrail anchoring member 80a is located. For example, the anchoring elastic member 80b is a torsion spring, and the torsion spring is sleeved on a pivot structure 81 of the handrail anchoring member 80a (the pivot structure 81 is pivotally connected to the front leg 20a). Moreover, the torsion spring has one end 82 abutting against the handrail anchoring member 80a, and the other end 83 arranged on the front leg 20a, such that the assembly connections of the anchoring elastic member 80b respectively to the handrail anchoring member 80a and the front leg 20a are more reasonable and compact, and the automatic pivoting of the handrail anchoring member 80a is smoother, but the disclosure is not limited to this. In addition, a bottom end of the sleeve 71 is pivotally connected to the front leg and the cooperatively anchoring structure 80b is located at a top of the sleeve 71, so as to facilitate the handrail anchoring member 80a to anchor the handrail 70 and the front leg 20a when the handrail 70 is pivoted to the pushed backward position shown in FIG. 6. For example, handrail anchoring member 80a may be a hook structure, and correspondingly, the cooperatively anchoring structure 80b may be a slotted structure, but the disclosure is not limited to this. It would be understood, when the handrail anchoring member 80a is assembled on the sleeve 71, correspondingly, the anchoring elastic member 80b is arranged between the sleeve 71 and the handrail anchoring member 80a.

As shown in FIGS. 1 to 6, the front leg 20a, the rear leg 20b, the base 111, and the movable mount 12 are respectively arranged at intervals to be one on left and one on right, so as to ensure a standing and retracting reliability of the baby stroller frame 1 of the first embodiment of the disclosure. The front carrying stand 30a, the rear carrying stand 30b, and the intermediate connecting support 112 each is in a shape of “U”, so as to facilitate the front carrying stand 30a, the rear carrying stand 30b, and the intermediate connecting support 112 to bear the baby carrier. Of course, according to actual requirements, the front carrying stand 30a, the rear carrying stand and the intermediate connecting support 112 may also have other shapes, so the disclosure is not limited to this. Furthermore, each of left and right sides of a rear end of the front carrying stand is pivotally connected to the movable mount 12 on the same side, and each of left and right sides of a front end of the front carrying stand 30a is pivotally connected to the front leg 20a on the same side; each of left and right sides of a front end of the rear carrying stand 30b is pivotally connected to the movable mount 12 on the same side, and each of left and right sides of a rear end of the rear carrying stand 30b is pivotally connected to the rear leg 20b on the same side; the front legs 20a on both left and right sides are respectively pivotally connected to the bases 11 on the same side, and the rear legs 20b on both left and right sides are respectively pivotally connected to the bases 111 on the same side; and both left and right sides of a top end of the intermediate connecting support 112 are respectively assembled and connected with the bases 111 on the same side; such design may ensure more reliably that during the process that the front legs 20a and the rear legs 20b are retracted to close each other, the front carrying stand 30a and the rear carrying stand 30b are correspondingly linked to be retracted to close to each other. Moreover, the front carrying stand 30a and the rear carrying stand 30b also follow the movable mount 12 to slide on the intermediate connecting support 112 during retracting process, thereby ensuring a retracting reliability of the baby stroller frame 1 of the first embodiment of the disclosure.

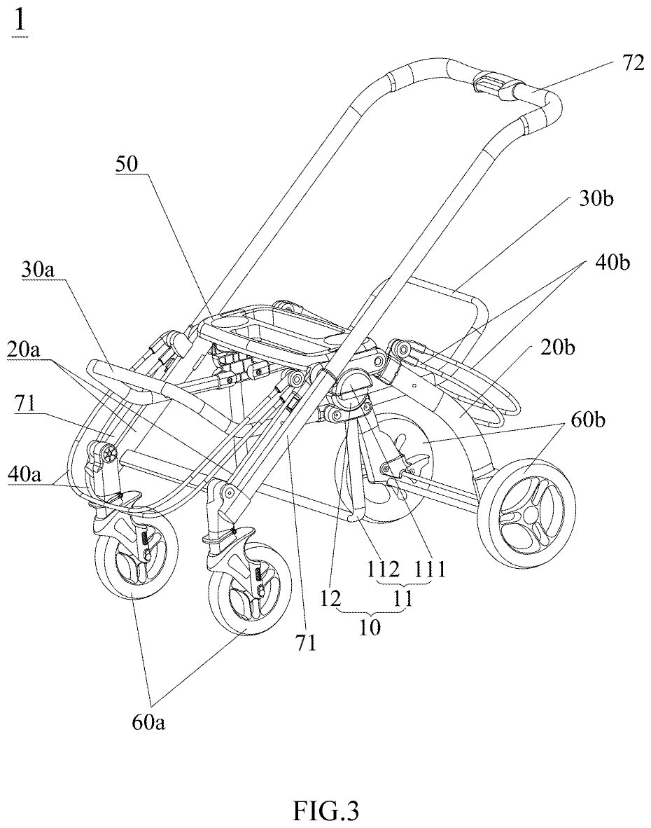

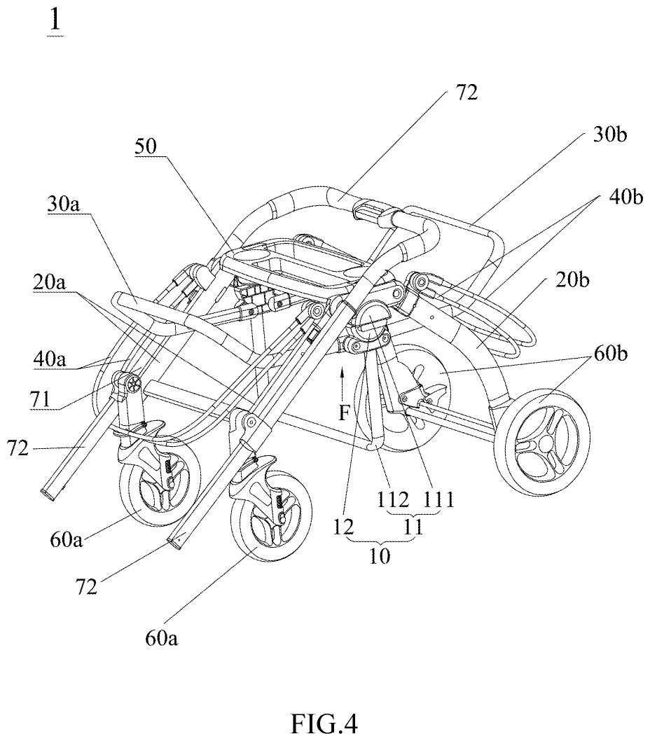

With reference to the drawings, the retracting process of the baby stroller frame of the first embodiment of the disclosure will be described. When the baby stroller frame 1 in the stretched position shown in FIG. 1 is to be retracted into the retracted position shown in FIG. 5, at first the front canopy support 40a is retracted backward and downward to a position abutting against the front leg 20a, and the rear canopy support 40b is retracted backward and downward to a position abutting against the rear leg 20b, such state is shown in FIG. 3; next, the handrail 70 is unlocked, and the hand lever 72 in the handrail 70 is retracted into the sleeve 71, such that a bottom end of the hand lever 72 in the handrail 70 passes through the sleeve 71 and extends to the front of the front wheel 60a, such state is shown in FIG. 4; then, the user's left and right hands respectively apply an upward operating force F to the corresponding operating member 14, and the operating member 14 drives the locking member 13 to slide out of the slotted structure 121 of the movable mount 12 by the cooperation of the driving inclined surface 141 and the driven inclined surface 131, so as to allow the movable mount 12 to slide down on the intermediate connecting support 112; next directly, the front leg 20a and the rear leg 20b are retracted downwardly close to each other, and linked by the front leg 20a and the rear leg 20b being retracted downwardly close to each other, the front carrying stand 30a and the rear carrying stand 30b are retracted upwardly close to each other, and the front carrying stand 30a and the rear carrying stand 30b need to follow the movable mount 12 to slide down on the intermediate connecting support 112 during the process of being retracted upwardly close to each other, the final retracted state is shown in FIG. 5. When the handrail 70 in the baby stroller frame 1 of the first embodiment of the disclosure is to be switched from the pushed backward position shown in FIG. 1 to the dragged forward position shown in FIG. 5, what the operator need to do at this time is to make the handrail anchoring member 80a unlock the handrail 70 and the front leg 20a, then make the handrail 70 be pivoted to the dragged forward position shown in FIG. 5.

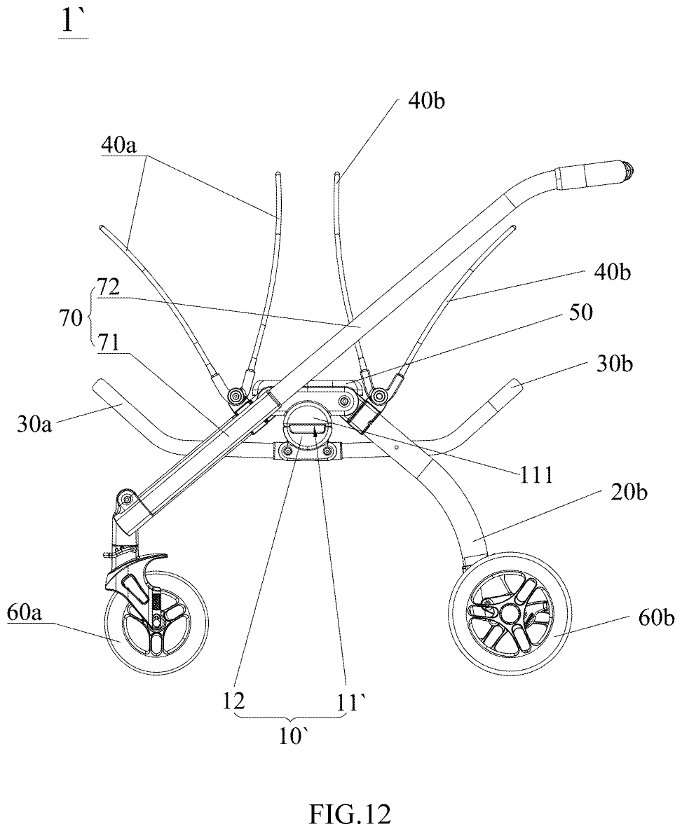

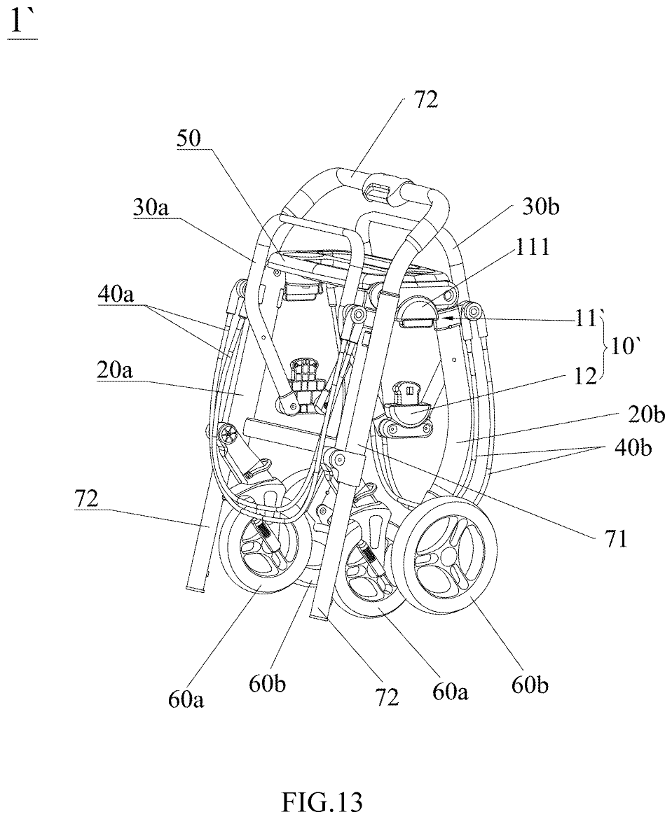

Please refer to FIGS. 12 and 13, the structure of the baby stroller frame 1′ according to the second embodiment of the disclosure is basically as same as the structure of the baby stroller frame 1 according to the first embodiment, the difference lies in the device skeletons in their retracting-stretching devices. The related description is as follows.

Compared with the device skeleton 11 in the retracting-stretching device 10 of the baby stroller frame 1 of the first embodiment, in the baby stroller frame 1′ of the second embodiment, the intermediate connecting support 112 is not arranged in the device skeleton 11′ of the retracting-stretching device 10′, that is, the device skeleton 11′ does not include the intermediate connecting support 112. At this time, the movable mount 12 in the retracting-stretching device 10′ is separably connected to the device skeleton 11′, so that the movable mount 12 of the retracting-stretching device 10′ is engaged with the device skeleton 11′ when the baby stroller frame 1′ is in the stretched position, such state is shown in FIG. 12, and the movable mount 12 is separated from the device skeleton 11′ when the baby stroller frame 1′ is in the retracted position. Therefore, the front leg 20a and the rear leg 20b in the process of pivotally retracting close to each other may link the front carrying stand 30a and the rear carrying stand 30b to follow the separation of the movable mount 12 in respect to the device skeleton 11′ to pivotally retract close to each other. Moreover, in the first embodiment, since the movable mount 12 is slidably arranged on the device skeleton 11, specifically, slidably arranged on the intermediate connecting support 112 of the device skeleton 11, the movable mount 12 slides toward the base 111 of the device skeleton 11 when the baby stroller frame 1 is in the stretched position, such that the movable mount 12 slides away from the base 111 of the device skeleton 11 when the baby stroller frame 1 is in the retracted position. Therefore, the front leg 20a and the rear leg 20b during the process of pivotally retracting downwardly close to each other also link the front carrying stand 30a and the rear carrying stand 30b to slide along with the movable mount 12.

Except for the above differences, the second embodiment is the same as the first embodiment, so the other features will not be repeated here.

Compared with the related art, since the front leg 20a is pivotally connected to the retracting-stretching device 10, the rear leg 20b is pivotally connected to the retracting-stretching device 10, and the rear leg 20b performs stretching or retracting movement with the front leg 20a in respect to each other by assistance of the retracting-stretching device 10; at the same time, the front carrying stand 30a is pivotally connected to the retracting-stretching device 10, the rear carrying stand 30b is pivotally connected to the retracting-stretching device 10, and the rear carrying stand 30b performs stretching or retracting movement with the front carrying stand 30a in respect to each other by assistance of the retracting-stretching device 10. Therefore, in the process that the baby stroller frame 1 (1′) of the disclosure is switched from the stretched position shown in FIG. 1 to the retracted position shown in FIG. 5, while the front leg 20a and the rear leg are pivotally retracting close to each other, the front carrying stand 30a and the rear carrying stand 30b are pivotally retracting close to each other, so on the one hand, the front leg 20a, the rear leg 20b, the front carrying stand 30a, and the rear carrying stand 30b after retracted are compact, such that the baby stroller frame 1 (1′) of the disclosure occupies a smaller space, and on the other hand, the retracting operation of the baby stroller frame 1 (1′) of the disclosure is convenient.

What disclosed above are only preferred embodiments of the disclosure, and the scope of the disclosure certainly cannot be limited by this. Therefore, any equivalent changes made according to the scope of the disclosure still belong to the disclosure.

1. A baby stroller frame switchable between a stretched position and a retracted position, wherein the baby stroller frame comprises:
a retracting-stretching device;
a front leg pivotally connected to the retracting-stretching device;
a rear leg pivotally connected to the retracting-stretching device, the rear leg and the front leg performing a stretching or retracting movement in respect to each other by assistance of the retracting-stretching device;
a front carrying stand pivotally connected to the retracting-stretching device; and
a rear carrying stand pivotally connected to the retracting-stretching device, the rear carrying stand and the front carrying stand performing a stretching or retracting movement in respect to each other by assistance of the retracting-stretching device;
wherein during a process that the baby stroller frame is switched from the stretched position to the retracted position, while the front leg and the rear leg are pivotally retracting close to each other, the front carrying stand and the rear carrying stand are pivotally retracting close to each other, thereby achieving a retracting of the baby stroller frame.

2. The baby stroller frame according to claim 1, wherein the front carrying stand is connected to the front leg, and the rear carrying stand is connected to the rear leg.

3. The baby stroller frame according to claim 2, wherein the front carrying stand is pivotally connected to the front leg, the rear carrying stand is pivotally connected to the rear leg; and during a process that the front leg and the rear leg are pivotally retracting close to each other, the front carrying stand and the rear carrying stand are linked to pivotally retract close to each other.

4. The baby stroller frame according to claim 3, wherein during a process that the front leg and the rear leg are pivotally retracting upwardly close to each other, the front carrying stand and the rear carrying stand are linked to be pivotally retracting downwardly close to each other; or during a process that the front leg and the rear leg are pivotally retracting downwardly close to each other, the front carrying stand and the rear carrying stand are linked to be pivotally retracting upwardly close to each other.

5. The baby stroller frame according to claim 1, wherein the front carrying stand is located on an inner side of the front leg, and the rear carrying stand is located on an inner side of the rear leg.

6. The baby stroller frame according to claim 3, wherein the retracting-stretching device includes:
a device skeleton pivotally connected to the front leg and the rear leg respectively; and
a movable mount slidably arranged on the device skeleton, the movable mount being pivotally connected to the front carrying stand and the rear carrying stand respectively;
and during a process that the front leg and the rear leg are pivotally retracting close to each other, the front carrying stand and the rear carrying stand are also linked to slide along with the movable mount.

7. The baby stroller frame according to claim 6, wherein the device skeleton includes a base pivotally connected to the front leg and rear the leg respectively and an intermediate connecting support with a top end assembled on the base, and the movable mount is slidably arranged on the intermediate connecting support in the up-down direction.

8. The baby stroller frame according to claim 7, wherein the retracting-stretching device further includes a locking member, the locking member is movably arranged on one of the device skeleton and the movable mount, and the other one of the device skeleton and the movable mount is provided with a slotted structure for cooperating with the locking member, and the locking member is switchable between a locked position for locking with the slotted structure and an unlocked position for separating from the slotted structure.

9. The baby stroller frame according to claim 8, wherein the locking member is located on the base, and the intermediate connecting support is provided with a through hole for the locking member to move through and to be locked with the slotted structure.

10. The baby stroller frame according to claim 9, wherein the locking member is axially slidable in the through hole.

11. The baby stroller frame according to claim 8, wherein the retracting-stretching device further includes:
an operating member movably arranged on the device skeleton or the movable mount on which the locking member is located, and the operating member is used to drive the locking member to move to the unlocked position.

12. The baby stroller frame according to claim 11, wherein the operating member is provided with a driving inclined surface inclined in respect to an axial direction, the locking member is provided with a driven inclined surface cooperating with the driving inclined surface, and the operating member during a moving process drives the locking member to move to the unlocked position by a cooperation of the driving inclined surface and the driven inclined surface.

13. The baby stroller frame according to claim 12, wherein the operating member is a button, and the button is slidable in the up-down direction.

14. The baby stroller frame according to claim 8, wherein the retracting-stretching device further includes:
an elastic element for driving the locking member to move to the locked position.

15. (canceled)

16. The baby stroller frame according to claim 1, wherein the baby stroller frame further comprises a front canopy support and a rear canopy support; the front canopy support is pivotally connected to the front leg, the rear canopy support is pivotally connected to the rear leg; and during a process that the baby stroller frame is switched from the stretched position to the retracted position, the front canopy support is pivoted forward and downward to a position abutting against the front leg, and the rear canopy support is pivoted backward and downward to a position abutting against the rear leg.

17. The baby stroller frame according to claim 6, wherein the baby stroller frame further comprises:
a dining plate detachably assembled to the device skeleton.

18. The baby stroller frame according to claim 17, wherein an elastic engaging finger is formed on the dining plate, and the dining plate is clamped to the device skeleton by assistance of the elastic engaging finger.

19. The baby stroller frame according to claim 18, wherein the elastic engaging finger extends downward and protrudes.

20. The baby stroller frame according to claim 1, wherein the baby stroller frame further comprises a front wheel arranged at a bottom of the front leg and a rear wheel arranged at a bottom of the rear leg, and the front wheel and the rear wheel abut against each other when the baby stroller frame is in the retracted position.

21. The baby stroller frame according to claim 1, wherein the baby stroller frame further comprises a handrail pivotally connected to the front leg, the handrail is switchable between a pushed backward position and a dragged forward position, when the handrail is pivoted to the pushed backward position it is be on the same side as the rear leg, when the handrail is pivoted to the dragged forward position it is be on the same side as the front leg.

22. The baby stroller frame according to claim 21, wherein the handrail is located on an outer side of both the front leg and the rear leg.

23. The baby stroller frame according to claim 20, wherein the baby stroller frame further comprises a handrail, the handrail includes a sleeve assembled on the front leg and a hand lever arranged passing through the sleeve; a bottom end of the hand lever passes downward through the sleeve and extends to a front of the front wheel when the baby stroller frame is in the retracted position, such that the baby stroller frame stands on the ground by assistance of a bottom end of the hand lever, the front wheel, and the rear wheel.

24. The baby stroller frame according to claim 23, wherein the sleeve is pivotally connected to the front leg, the handrail is switchable between a pushed backward position and a dragged forward position, when the handrail is pivoted to the pushed backward position it is on the same side as the rear leg, and when the handrail is pivoted to the dragged forward position it is on the same side as the front leg.

25.-32. (canceled)
